(19) United States
(12) Patent Application Publication
(10) Pub. No.: US 2024/0413456 A1
(43) Pub. Date: Dec. 12, 2024

(54) BATTERY ASSEMBLY

(71) Applicant: Dr. Ing. h. c. F. Porsche Aktiengesellschaft, Stuttgart (DE)

(72) Inventor: Dominik Grass, Bietigheim-Bissingen (DE)

(73) Assignee: Dr. Ing. h. c. F. Porsche Aktiengesellschaft, Stuttgart (DE)

(21) Appl. No.: 18/735,263

(22) Filed: Jun. 6, 2024

(30) Foreign Application Priority Data
Jun. 7, 2023 (DE) 102023114919.9

(51) Int. Cl. H01M 50/242; H01M 10/04; H01M 50/249

(52) U.S. Cl. CPC H01M 50/242; H01M 10/0468; H01M 50/249

(57) ABSTRACT

A battery assembly has a battery housing and battery cells arranged parallel to one another in a housing interior in a first transverse direction (X) running perpendicular to an insertion direction. A compression pad is arranged between each of the battery cells. Furthermore, at least one contact element arranged in a corner of the interior of the battery housing is provided with a contact surface which is in contact with a battery cell or a component connected thereto in a force-fitting and/or form-fitting manner. The contact element is designed to exert a force via the contact surface on the battery cells or the component connected thereto in a force-fitting and/or form-fitting manner in a second transverse direction (Z) running perpendicular to the first transverse direction (X) on the battery cells and pressing the battery cells or the component connected thereto in a force-fitting and/or form-fitting manner against a stop.

### CROSS-REFERENCE TO RELATED APPLICATION

This application claims priority to German Patent Application No. 10 2023 114 919.9, filed Jun. 7, 2023, the content of such application being incorporated by reference herein in its entirety.

### FIELD OF THE INVENTION

The present invention relates to a battery assembly, in particular a high-voltage battery assembly, in particular for a motor vehicle and a motor vehicle having a battery assembly according to aspects of the invention.

### BACKGROUND OF THE INVENTION

Battery assemblies of traction batteries for motor vehicles with electric drive have a battery housing in which several battery cells are arranged. So-called compression pads are arranged between the battery cells, which absorb cell swelling caused by operation and are made of an elastic material for this purpose. The battery cells arranged next to each other must be braced in the battery housing via the compression pads in order to ensure precise and clear positioning of the battery cells. The assembly of battery cells and compression pads is referred to as a cell stack in the context of the application. The exact position in which the cell stack is to be braced in the housing should be as precise as possible.

Various options are known in the state of the art for tensioning the battery cells. A battery assembly is known from patent document DE102020118890A1, which is incorporated by reference herein, which comprises a plurality of battery cells arranged adjacent to one another in a transverse direction, wherein a variable-volume compression mat is arranged in the housing adjacent to one of the battery cells, by means of which a contact pressure present between the battery cells can be adjusted.

Patent specification DE102019210194A1, which is incorporated by reference herein, describes a battery cell stack for a traction battery, which comprises a plurality of battery cells arranged next to one another in a transverse direction, wherein compression pads can be arranged between the battery cells, and wherein latching elements are provided for latching the battery cell stack in a housing.

Patent specification DE102016212783A, which is incorporated by reference herein, describes a battery assembly comprising a plurality of battery cells arranged next to one another in a transverse direction, wherein a pressure element, preferably in the form of a spring element, is provided in order to brace the battery cells in the housing.

Document DE102020005245A1, which is incorporated by reference herein, deals with a battery module which comprises a plurality of battery cells arranged side by side in a transverse direction, wherein a housing interior is pressurized with an overpressure by means of a fluid in order to brace the battery cells.

### SUMMARY OF THE INVENTION

Against the background of the state of the art described above, described herein is a battery assembly with a means of positioning the battery cells for bracing in a battery housing and a vehicle with such a battery assembly.

The battery assembly according to aspects of the invention has a battery housing with a cuboid interior, wherein at least two battery cells arranged parallel to one another are arranged in the interior in a first transverse direction running perpendicular to an insertion direction. The insertion direction is defined by the direction in which the battery cells are inserted through an opening in the interior of the battery housing. The first transverse direction is defined accordingly as the direction in which the battery cells are arranged next to each other. A compression pad is arranged between each of the battery cells, whereby according to aspects of the invention at least one compression pad is arranged between the at least two battery cells. Furthermore, at least one contact element arranged in a corner of the interior of the battery housing is provided with a contact surface which is in contact with a battery cell or a component connected thereto in a force-fitting and/or form-fitting manner, wherein the contact element is designed to exert force on the battery cells or the component connected thereto in a force-fitting and/or form-fitting manner via the contact surface in a second transverse direction running perpendicular to the first transverse direction on the battery cells and to press the battery cells or the component connected thereto in a force-fitting and/or form-fitting manner against a stop.

By pressing the cell stack against the stop, a stable and precise positioning of the cell stack in the battery housing can be achieved by implementing simple geometric elements as contact elements.

In a preferred embodiment of the invention, at least one contact surface of the contact element is designed as an inclined plane. This means that the contact surface does not have any bulges or indentations. A simple geometric design of the contact element can be ensured by providing a corresponding contact surface.

In a preferred embodiment of the invention, a wall of the battery housing is provided as a stop. Consequently, the cell stack or the battery cells or a component connected to it in a force-fitting and/or form-fitting manner is pressed against a wall of the battery housing in the second transverse direction by the force exerted on the cell stack by the contact element.

Another preferred embodiment of the invention is one in which two contact elements are arranged on two opposite sides with respect to the second transverse direction. This ensures that one contact element is arranged on one side of the cell stack and one contact element on the opposite side of the cell stack. This ensures symmetrical tensioning of the cell stack in the first transverse direction. Such an embodiment is particularly preferred if the contact elements are also arranged on the same side of the interior of the battery housing in relation to the first transverse direction. In this way, an embodiment can be produced in which the cell stack is braced in the first transverse direction and at the same time a force is applied to the cell stack in the direction of the second transverse direction, which presses the cell stack against the housing in the direction of the second transverse direction. In this way, a defined position of the cell stack can be achieved with a corresponding tensioning of the cell stack.

In a further advantageous embodiment of the invention, the at least one contact element is formed from an elastic material, wherein in particular an elasticity of the contact element is lower than an elasticity of the at least one compression pad. This can result in a slight deformation of the contact element, whereby the cell stack is tensioned by deformation of both the compression pads and the contact element. The lower elasticity of the contact element ensures that the force required to deform the contact element must be greater than the force required to deform the compression pad, so that the compression pad deforms in front of the contact element.

The motor vehicle according to aspects of the invention has a battery assembly according to aspects of the invention.

### BRIEF DESCRIPTION OF THE DRAWINGS

In the following, advantageous aspects and embodiments are explained in more detail with reference to the attached figures. The figures show:

FIG. 1 shows an embodiment of a battery assembly 1 according to aspects of the invention in a cross-section parallel to an insertion direction Y.

FIG. 2 shows the embodiment of the battery assembly 1 according to FIG. 1 in a cross-section perpendicular to the insertion direction Y.

### DETAILED DESCRIPTION OF THE INVENTION

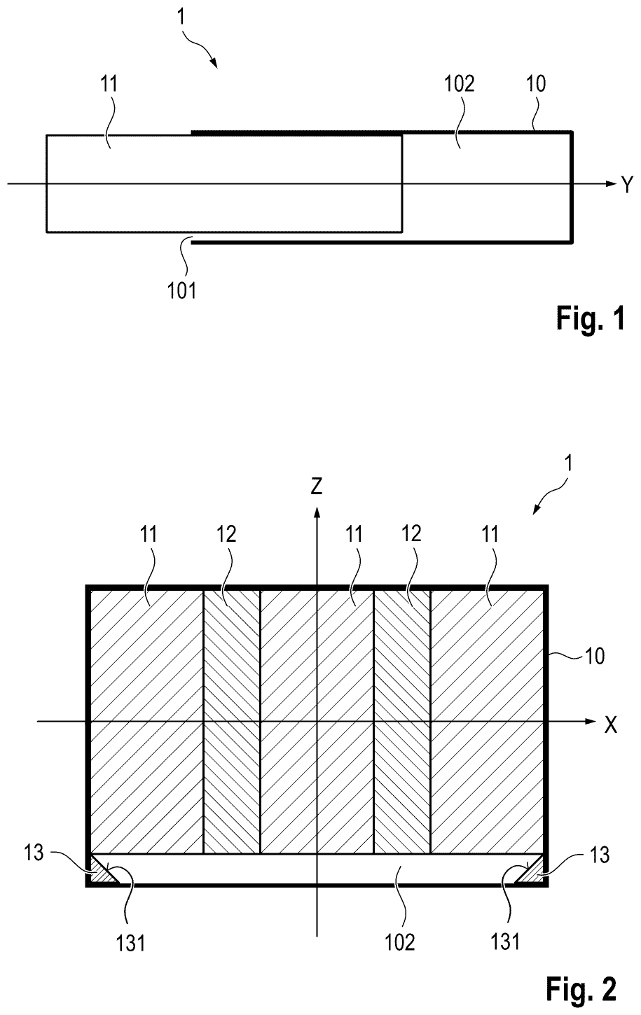

FIG. 1 shows an embodiment of a battery assembly 1 according to aspects of the invention in a cross-section parallel to an insertion direction Y. The battery assembly 1 has a battery housing 10 with a cuboid interior 102. A battery cell 11 is inserted into the interior 102 in the plane of the drawing from left to right through an opening 101 in the battery housing 10. This direction of movement also defines the insertion direction Y.

It should be noted that only one battery cell 11 can be seen in the cross-section shown, wherein this is correctly a complete cell stack, i.e. the combination of several battery cells 10 arranged one behind the other in the perspective shown in FIG. 1 and compression pads provided between them (see FIG. 2). In a fully assembled state of the battery assembly 1, the cell stack is of course located completely in the interior 102 of the battery housing 10.

FIG. 2 shows the embodiment of the battery assembly 1 according to FIG. 1 in a cross-section perpendicular to the insertion direction Y. The cell stack consists of three battery cells 11 and compression pads 12 arranged between them, which, among other things, absorb the operational cell swelling of the battery cells 11. The battery cells 11 are arranged next to each other in a first transverse direction X to the insertion direction. The direction perpendicular to the first transverse direction X and perpendicular to the insertion direction Y is referred to as the second transverse direction Z.

Two contact elements 13 with a triangular cross-section are arranged in the interior 102 of the housing 10. With respect to the second transverse direction Z, the contact elements 13 are arranged on opposite sides of the interior 102. With respect to the first transverse direction X, however, the contact elements 13 are arranged on the same side of the interior 102 of the battery housing 10. In other words, the contact elements 13 are positioned in the lower corners of the interior 102 in the plane of the drawing. They preferably extend over the entire length of the interior 102 in the insertion direction, wherein embodiments of the invention are also conceivable in which the contact elements 13 are only formed in places over the length of the battery housing 10 in the insertion direction.

The contact elements 13 have contact surfaces 131 which are designed as inclined planes and fill the corresponding corners of the interior with the inclined contact surface 131.

If the cell stack consisting of battery cell 11 and compression body 12 is inserted into the battery housing 10 in a slightly compressed state in the insertion direction Y (see FIG. 1), the outer battery cells 11 are in contact with the inclined contact surfaces 131 of the contact elements 13. If the compression pads 12 now expand slightly in the direction of the first transverse direction X, the support elements 13 with the inclined contact surfaces 131 apply a force in the direction of the second transverse direction Z to the battery cells 11 and thus to the cell stack, which is directed upwards in the plane of the drawing and pushes the cell stack in this direction and presses it against the upper wall of the battery housing 10 as a stop. In the end position, the cell stack is then braced against the battery housing 10 by the external battery cells 11. In this way, a defined positioning of the cell stack and the battery cells 11 within the battery housing 10 can be ensured.

### REFERENCE NUMERALS

1 Battery assembly
10 Battery housing
101 Opening
102 Interior
11 Battery cell
12 Compression pad
13 Contact elements
131 Contact surface
X Insertion direction
Y First transverse direction
Z Second transverse direction

What is claimed is:

1. A battery assembly comprising:
a battery housing having a cuboid interior,
at least two battery cells arranged parallel to one another in the cuboid interior of the battery housing in a first transverse direction (X) extending perpendicular to an insertion direction (Y) of the battery cells,
at least one compression pad arranged between the at least two battery cells, and
at least one contact element arranged in a corner of the interior of the battery housing,
wherein the at least one contact element has a contact surface which is in contact with at least one battery cell or a component connected thereto in a force-fitting and/or form-fitting manner,
wherein the contact element is configured to exert a force, via the contact surface, on the battery cells or the component connected thereto in a second transverse direction (Z) running perpendicular to the first transverse direction (X) which causes the battery cells or the component connected thereto to bear against a stop.

2. The battery assembly according to claim 1, wherein the contact surface of the contact element is an inclined plane.

3. The battery assembly according to claim 1, wherein the stop is a wall of the battery housing.

4. The battery assembly according to claim 1, wherein two of the contact elements are arranged on two sides of the interior of the battery housing opposite each other with respect to the second transverse direction (Z).

5. The battery assembly according to claim 4, wherein the contact elements are arranged on a same side of the interior of the battery housing with respect to the first transverse direction (X).

6. The battery assembly according to claim 1, wherein the at least one contact element comprises an elastic material.

7. The battery assembly according to claim 6, wherein an elasticity of the at least one contact element is lower than an elasticity of the at least one compression pad.

8. A motor vehicle comprising the battery assembly according to claim 1.
